(19) United States
(12) Patent Application Publication
(10) Pub. No.: US 2024/0295938 A1
(43) Pub. Date: Sep. 5, 2024

(54) TOUCH SYSTEM, STYLUS, TOUCH DEVICE, TOUCH PROCESSING CIRCUIT, AND OPERATION METHOD THEREOF

(71) Applicant: Novatek Microelectronics Corp., Hsinchu (TW)

(72) Inventors: Chih-Yang Ke, Tainan City (TW); Chin-Lin Lee, Hsinchu City (TW)

(73) Assignee: Novatek Microelectronics Corp., Hsinchu (TW)

(21) Appl. No.: 18/178,518

(22) Filed: Mar. 5, 2023

(51) Int. Cl. G06F 3/041; G06F 3/0354; G06F 3/038

(52) U.S. Cl. CPC G06F 3/04186; G06F 3/03545; G06F 3/0383; G06F 2203/04106

(57) ABSTRACT

A touch system, a stylus, a touch device, a touch processing circuit, and an operation method thereof are provided. The stylus includes a holding portion and a first transmission electrode. The first transmission electrode is disposed on the holding portion. When the hand of the user holds the holding portion of the stylus, the first transmission electrode transmits a suppressing report signal. The touch device includes a touch panel to detect a touch event. The touch device detects the suppressing report signal of the first transmission electrode through the touch panel to determine a false touch area of the hand on the touch panel. The touch device ignores the touch event of the false touch area when the hand touches the false touch area by mistake.

### BACKGROUND

### Technical Field

The disclosure relates to an electronic equipment, and in particular to a touch system, a stylus, a touch device, a touch processing circuit, and an operation method thereof.

### Description of Related Art

More and more electronic equipment (for example, touch devices such as laptops, tablet computers, and mobile phones) are equipped with active stylus to provide users with more human-computer interaction manners. The user may hold the active stylus to write on the touch panel of the touch device. When the active stylus held by the hand approaches the touch panel, the palm (or the wrist) usually touches the touch panel first, and the active stylus then touches the touch panel. The contact area (the false touch area) of the palm (or the wrist) on the touch panel should be ignored. Since the false touch area of the palm (or the wrist) is not large in the case where the hand holds the active stylus, there is no discrimination between the false touch area and the normal finger operation gesture (for example, a single finger quick swipe or a single finger quick click) from the signal surface. The system may falsely report the touch coordinates of the false touch area. How to effectively identify the false touch area is one of many technical issues in the art.

### SUMMARY

The disclosure provides a touch system, a stylus, a touch device, a touch processing circuit, and an operation method thereof, so as to effectively identify a false touch area of a hand in the case where the hand holds the stylus.

In an embodiment of the disclosure, the touch system includes a stylus and a touch device. The stylus includes a holding portion and a first transmission electrode. The first transmission electrode is disposed on the holding portion. The first transmission electrode transmits a suppressing report signal in a case where a hand holds the holding portion of the stylus. The touch device includes a touch panel to detect a touch event. The touch device detects the suppressing report signal of the first transmission electrode through the touch panel to determine a false touch area of the hand on the touch panel. The touch device ignores the touch event of the false touch area when the hand touches the false touch area by mistake.

In an embodiment of the disclosure, the operation method of the touch system includes the following steps. A suppressing report signal is transmitted by a first transmission electrode of a stylus. The first transmission electrode is disposed on a holding portion of the stylus, and the first transmission electrode transmits a suppressing report signal in a case where a hand holds the holding portion of the stylus. The suppressing report signal of the first transmission electrode is detected by a touch panel of a touch device. A false touch area of the hand on the touch panel is determined based on the suppressing report signal. A touch event of the false touch area is ignored when the hand touches the false touch area by mistake.

In an embodiment of the disclosure, the stylus includes a holding portion and a first transmission electrode. The first transmission electrode is disposed on the holding portion. The first transmission electrode transmits a suppressing report signal in a case where a hand holds the holding portion of the stylus. The suppressing report signal is used to make a touch device to ignore a touch event of a false touch area of the hand on a touch panel.

In an embodiment of the disclosure, the operation method of the stylus includes the following steps. A holding portion of the stylus is provided. A suppressing report signal is transmitted by a first transmission electrode disposed on the holding portion in a case where a hand holds the holding portion of the stylus. The suppressing report signal is used to make a touch device to ignore a touch event of a false touch area of the hand on a touch panel.

In an embodiment of the disclosure, the touch device includes a touch panel and a touch processing circuit. The touch panel is used to detect a touch event. The touch processing circuit is coupled to the touch panel. A stylus transmits a suppressing report signal in a case where a hand holds the stylus. The touch processing circuit detects the suppressing report signal of the stylus through the touch panel to determine a false touch area of the hand on the touch panel. The touch processing circuit ignores a touch event of the false touch area when the hand touches the false touch area by mistake.

In an embodiment of the disclosure, the operation method of the touch device includes the following steps. A touch event is detected by a touch panel of the touch device. A suppressing report signal of a stylus is detected through the touch panel by a touch processing circuit of the touch device. The stylus transmits the suppressing report signal in a case where a hand holds the stylus. A false touch area of the hand on the touch panel is determined based on the suppressing report signal. The touch event of the false touch area is ignored when the hand touches the false touch area by mistake.

In an embodiment of the disclosure, the touch processing circuit includes a driving circuit and a microcontroller. The driving circuit is used to couple to a touch panel. A stylus transmits a suppressing report signal in a case where a hand holds the stylus. The driving circuit detects the suppressing report signal of the stylus through the touch panel. The microcontroller is coupled to the driving circuit. The microcontroller determines a false touch area of the hand on the touch panel based on the suppressing report signal. The microcontroller ignores a touch event of the false touch area when the hand touches the false touch area by mistake.

In an embodiment of the disclosure, the operation method of the touch processing circuit includes the following steps. A suppressing report signal of a stylus is detected through a touch panel by a driving circuit of the touch processing circuit. The stylus transmits the suppressing report signal in a case where a hand holds the stylus. A false touch area of the hand on the touch panel is determined based on the suppressing report signal by a microcontroller of the touch processing circuit. A touch event of the false touch area is ignored when the hand touches the false touch area by mistake.

Based on the above, the holding portion (for example, the body) of the stylus described in the embodiments of the disclosure is provided with the transmission electrode. When the hand holding the stylus approaches the touch panel, the suppressing report signal of the transmission electrode may be transmitted to the touch panel through the hand. The touch device detects the suppressing report signal of the hand through the touch panel to determine the false touch area of the hand on the touch panel. Therefore, the touch device may instantly and effectively identify the false touch area of the hand in the case where the hand holds the stylus. When the palm (or the wrist) touches the touch panel by mistake, the touch device may ignore the touch event of the false touch area based on the suppressing report signal.

In order for the features and advantages of the disclosure to be more comprehensible, the following specific embodiments are described in detail in conjunction with the drawings.

### BRIEF DESCRIPTION OF THE DRAWINGS

FIG. 1 is a schematic view of an operation scenario of a touch system according to an embodiment of the disclosure.

FIG. 2 is a schematic view of a circuit block of a stylus according to an embodiment of the disclosure.

FIG. 3 is a schematic view of a geometric layout of a transmission electrode according to an embodiment of the disclosure.

FIG. 4 is a schematic view of a geometric layout of a transmission electrode according to another embodiment of the disclosure.

FIG. 5 is a schematic view of a geometric layout of a transmission electrode according to yet another embodiment of the disclosure.

FIG. 6 is a cross-sectional schematic view of a transmission electrode of a stylus according to another embodiment of the disclosure.

FIG. 7 is a schematic flowchart of an operation method according to an embodiment of the disclosure.

### DETAILED DESCRIPTION OF DISCLOSED EMBODIMENTS

The term “coupling (or connection)” used in the entire specification (including the claims) of the disclosure may refer to any direct or indirect connection means. For example, if a first device is described as being coupled (or connected) to a second device, it should be interpreted that the first device may be directly connected to the second device or the first device may be indirectly connected to the second device through another device or certain connection means. Terms such as “first” and “second” mentioned in the entire specification (including the claims) of the disclosure are used to name the elements or to distinguish between different embodiments or ranges, but not to limit the upper limit or the lower limit of the number of elements or to limit the sequence of the elements. In addition, wherever possible, elements/components/steps using the same reference numerals in the drawings and the implementation manners represent the same or similar parts. Related descriptions of the elements/components/steps using the same reference numerals or using the same terminologies in different embodiments may be cross-referenced.

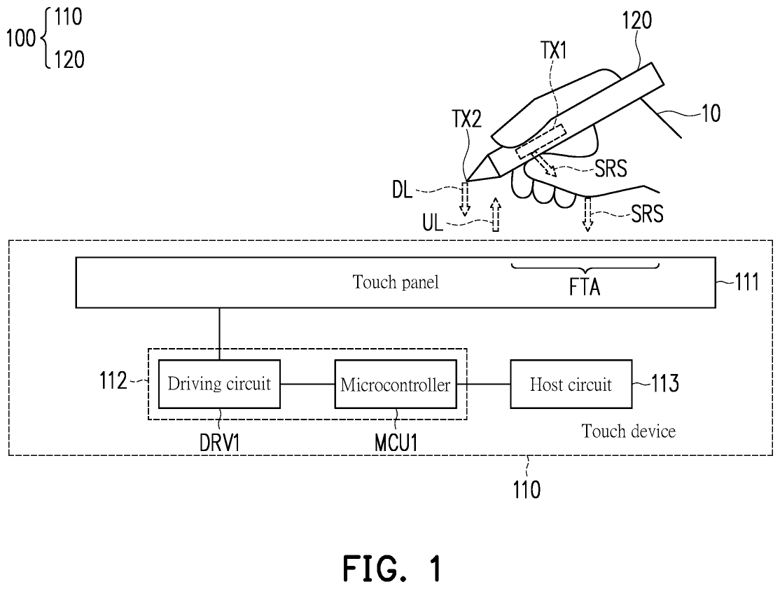

FIG. 1 is a schematic view of an operation scenario of a touch system 100 according to an embodiment of the disclosure. The touch system 100 includes a touch device 110 and a stylus 120. Based on the actual design, the touch device 110 may be implemented as a tablet computer, a smart phone, a monitor, a notebook computer, or other electronic equipment. A tip portion of the stylus 120 is provided with a transmission electrode TX2. The touch panel 111 of the touch device 110 may detect a touch event. When the stylus 120 is located above the touch panel 111, the touch device 110 may transmit an uplink signal UL to the stylus 120 through the touch panel 111, and receive a downlink signal DL sent by the transmission electrode TX2 of the tip portion of the stylus 120, so as to perform an active stylus touch detection operation. A user may operate the stylus 120 to write on the touch panel 111 of the touch device 110.

A hand 10 of the user may hold a holding portion (for example, the body) of the stylus 120 to use/operate the stylus 120 on the touch panel 111. When the tip portion of the stylus 120 touches the touch panel 111, the palm (or the wrist) often touches the touch panel 111 by mistake. A contact area (a false touch area FTA) of the palm (or the wrist) on the touch panel 111 should be ignored. When the tip portion of the stylus 120 touches the touch panel 111, the touch device 110 may define the false touch area FTA of the hand 10 based on the position of the tip portion of the stylus on the touch panel 111. However, during the process of the stylus 120 held by the hand 10 approaching the touch panel 111, the palm (or the wrist) usually touches the touch panel 111 first, and the tip portion of the stylus 120 then touches the touch panel 111. Before the tip portion touches the touch panel 111, the touch device 110 cannot use the position of the tip portion on the touch panel 111 to define the false touch area FTA of the hand 10.

In the embodiment shown in FIG. 1, the holding portion of the stylus 120 is provided with a transmission electrode TX1. In the case where the hand 10 holds the stylus 120, the transmission electrode TX1 may transmit a suppressing report signal SRS to the touch panel 111 through the hand 10. The touch device 110 may detect the suppressing report signal SRS of the transmission electrode TX1 through the touch panel 111. Based on the suppressing report signal SRS of the hand 10, the touch device 110 may determine the false touch area FTA of the hand 10 on the touch panel 111. When the hand 10 touches the false touch area FTA by mistake, the touch device 110 may instantly ignore the touch event of the false touch area FTA.

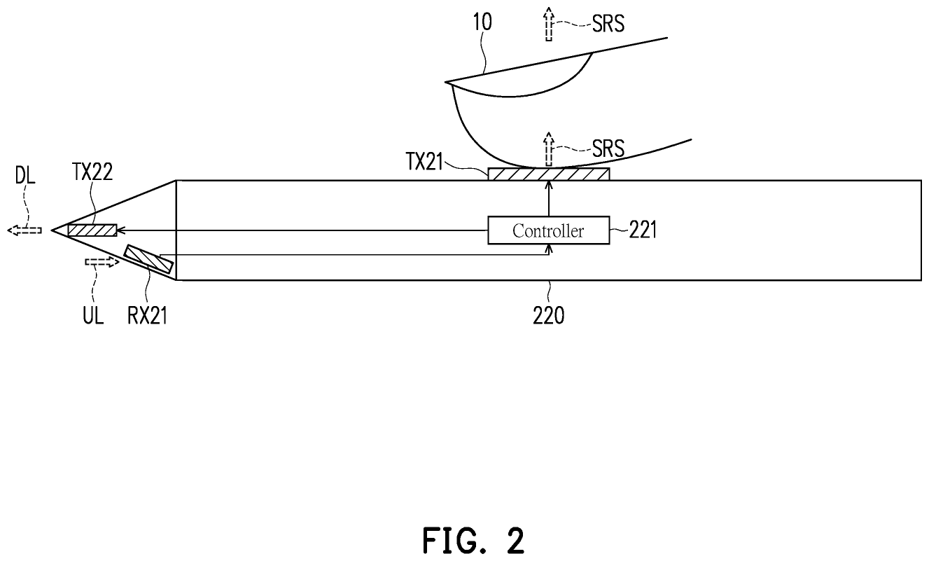

FIG. 2 is a schematic view of a circuit block of a stylus 220 according to an embodiment of the disclosure. The stylus 220 shown in FIG. 2 may be used as an example of the stylus 120 shown in FIG. 1. The stylus 220 shown in FIG. 2 includes a controller 221, a transmission electrode TX21, a transmission electrode TX22, and a receive electrode RX21. The transmission electrodes TX21 and TX22 shown in FIG. 2 may be used as an example of the transmission electrodes TX1 and TX2 shown in FIG. 1. The controller 221 shown in FIG. 2 is coupled to the transmission electrode TX21, the transmission electrode TX22, and the receive electrode RX21. Please refer to FIG. 1 and FIG. 2. When the stylus 220 is located above the touch panel 111, the touch device 110 may transmit the uplink signal UL to the stylus 220 through the touch panel 111. The tip portion of the stylus 220 is provided with the receive electrode RX21. The controller 221 may receive the uplink signal UL from the touch panel 111 through the receive electrode RX21. The tip portion of the stylus 220 is provided with the transmission electrode TX22. In the case where the tip portion is close to the touch panel 111, the controller 221 may transmit the downlink signal DL to the touch panel 111 through the transmission electrode TX22. Based on the downlink signal DL of the transmission electrode TX22, the touch device 110 may judge a touch position of the tip portion of the stylus 220 on the touch panel 111.

The controller 221 may also transmit the suppressing report signal SRS through the transmission electrode TX21. The hand 10 of the user may hold the body of the stylus 220 to use/operate the stylus 220 on the touch panel 111. The body (the holding portion) of the stylus 220 is provided with the transmission electrode TX21. In the embodiment shown in FIG. 2, when the hand 10 holds the body (the holding portion) of the stylus 220, the transmission electrode TX21 electrically contacts the hand 10. In the case where the hand 10 of the user holds the stylus 220, the transmission electrode TX21 may transmit the suppressing report signal SRS to the touch panel 111 through the hand 10. The suppressing report signal SRS is different from the downlink signal DL. The suppressing report signal SRS is used to make the touch device 110 to ignore the touch event of the hand 10 on the false touch area FTA of the touch panel 111.

The embodiment does not limit the geometric layout of the transmission electrode TX21. The following will illustrate several examples of the geometric layout of the transmission electrode TX21.

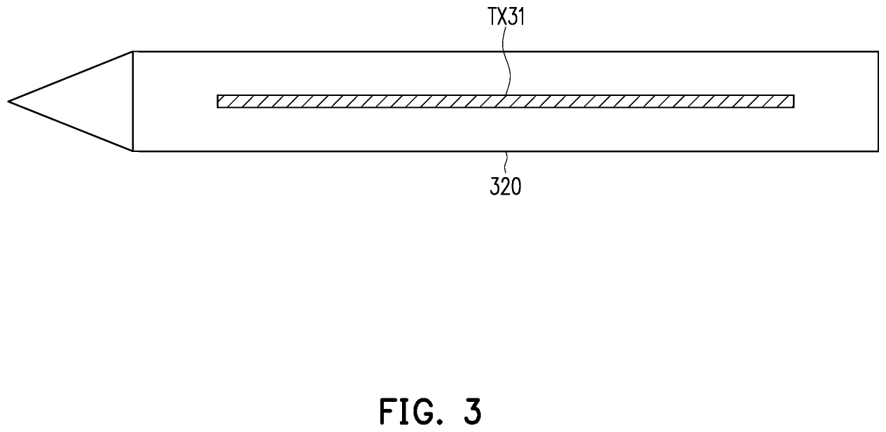

FIG. 3 is a schematic view of the geometric layout of the transmission electrode TX31 according to an embodiment of the disclosure. The stylus 320 and the transmission electrode TX31 shown in FIG. 3 may be used as an example of the stylus 120 and the transmission electrode TX1 shown in FIG. 1, or used as an example of the stylus 220 and the transmission electrode TX21 shown in FIG. 2. In the embodiment shown in FIG. 3, the transmission electrode TX31 is a wire disposed on the body (the holding portion) of the stylus 320. When the hand 10 of the user holds the body of the stylus 120, the hand 10 may receive/transmit the suppressing report signal SRS on the transmission electrode TX31.

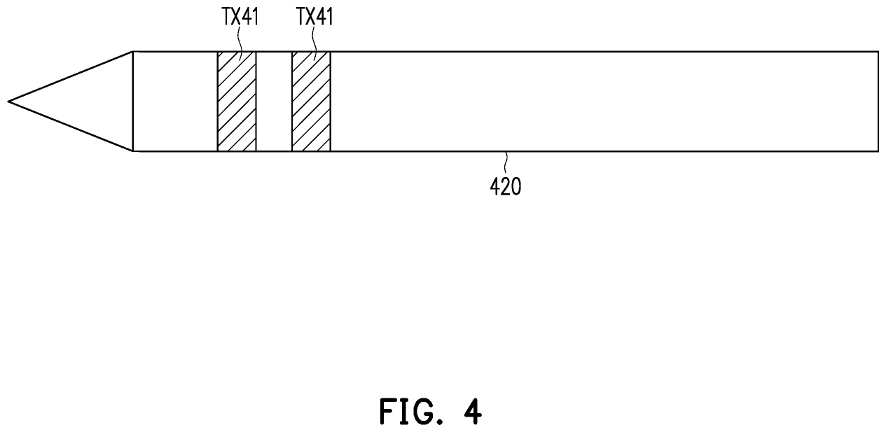

FIG. 4 is a schematic view of the geometric layout of the transmission electrode TX41 according to another embodiment of the disclosure. The stylus 420 and the transmission electrode TX41 shown in FIG. 4 may be used as an example of the stylus 120 and the transmission electrode TX1 shown in FIG. 1, or used as an example of the stylus 220 and the transmission electrode TX21 shown in FIG. 2. In the embodiment shown in FIG. 4, the transmission electrode TX41 is multiple (or one) conductor rings disposed on the body (the holding portion) of the stylus 420. When the hand 10 of the user holds the body of the stylus 420, the hand 10 may receive/transmit the suppressing report signal SRS on the transmission electrode TX41.

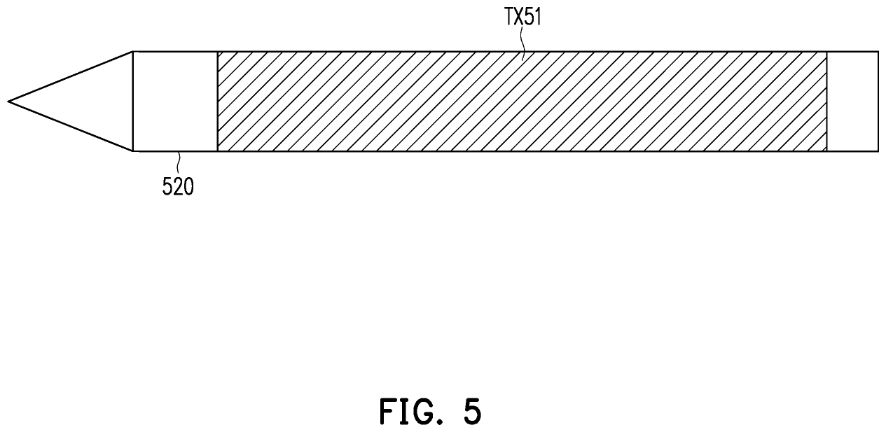

FIG. 5 is a schematic view of the geometric layout of the transmission electrode TX51 according to yet another embodiment of the disclosure. The stylus 520 and the transmission electrode TX51 shown in FIG. 5 may be used as an example of the stylus 120 and the transmission electrode TX1 shown in FIG. 1, or used as an example of the stylus 220 and the transmission electrode TX21 shown in FIG. 2. In the embodiment shown in FIG. 5, the transmission electrode TX51 is a conductor surface covering the body (the holding portion) of the stylus 520. When the hand 10 of the user holds the body of the stylus 520, the hand 10 may receive/transmit the suppressing report signal SRS on the transmission electrode TX51.

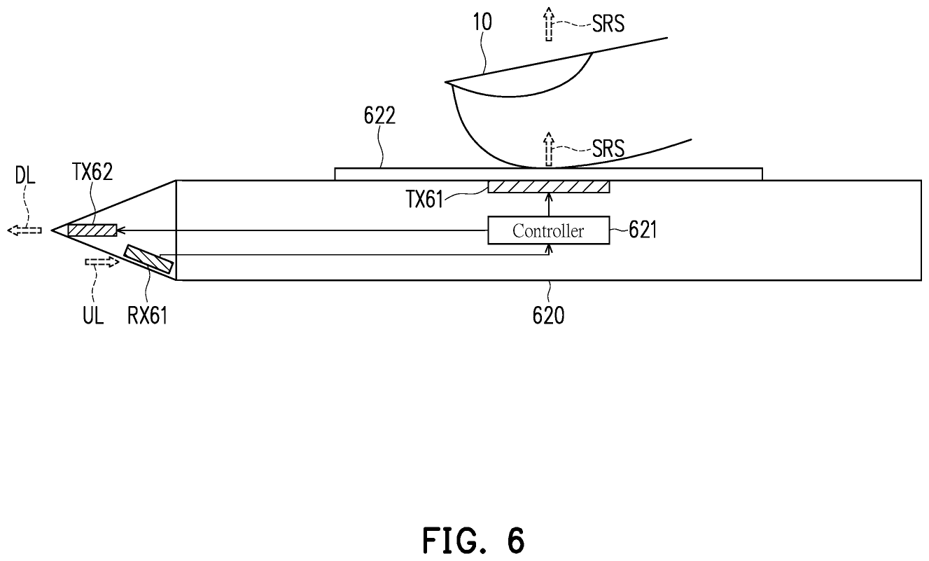

FIG. 6 is a cross-sectional schematic view of the transmission electrode TX61 of the stylus 120 according to another embodiment of the disclosure. For the stylus 620, the controller 621, the transmission electrode TX61, the transmission electrode TX62, and the receive electrode RX61 shown in FIG. 6, reference may be made to the relevant description of the stylus 220, the controller 221, the transmission electrode TX21, the transmission electrode TX22, and the receive electrode RX21 shown in FIG. 2, so details are not repeated here. Different from the embodiment shown in FIG. 2, the stylus 620 shown in FIG. 6 further includes an insulating layer 622. The insulating layer 622 is disposed on the transmission electrode TX61. When the hand 10 holds the body (the holding portion) of the stylus 620, the insulating layer 622 may prevent the transmission electrode TX61 from electrically contacting the hand 10.

FIG. 1 shows a schematic view of a circuit block of the touch device 110. The touch device 110 includes the touch panel 111, a touch processing circuit 112, and a host circuit 113. According to the actual design, the host circuit 113 may include a central processing unit (CPU) and/or other circuits. The touch processing circuit 112 may be a touch display driver integration (TDDI) circuit or other touch control circuits. Based on the control of the host circuit 113, the touch processing circuit 112 may drive/control the touch panel 111, so that the touch panel 111 detects the touch event. According to different designs, in some embodiments, the touch processing circuit 112 and (or) the host circuit 113 may be implemented as hardware circuits. In some other embodiments, the touch processing circuit 112 and (or) the host circuit 113 may be implemented in the form of firmware, software (that is, program), or a combination of the two. In yet other embodiments, the touch processing circuit 112 and (or) the host circuit 113 may be implemented in the form of a combination of multiple of hardware, firmware, and software.

In terms of the form of hardware, the touch processing circuit 112 and (or) the host circuit 113 may be implemented as logic circuits on an integrated circuit. For example, the relevant functions of the touch processing circuit 112 and (or) the host circuit 113 may be implemented in one or more controllers, microcontrollers, microprocessors, application-specific integrated circuits (ASIC), digital signal processors (DSP), field programmable gate arrays (FPGA), central processing units (CPU), and/or various logic blocks, modules, and circuits in other processing units. The relevant functions of the touch processing circuit 112 and (or) the host circuit 113 may be implemented as hardware circuits such as various logic blocks, modules, and circuits in integrated circuits by using hardware description languages (for example, Verilog HDL or VHDL) or other suitable programming languages.

In terms of the form of software and/or the form of firmware, the relevant functions of the touch processing circuit 112 and (or) the host circuit 113 may be implemented as programming codes. For example, the touch processing circuit 112 and (or) the host circuit 113 are implemented by using general programming languages (for example, C, C++, or assembly language) or other suitable programming languages. The programming codes may be recorded/stored in a “non-transitory machine-readable storage medium”. In some embodiments, the non-transitory machine-readable storage medium includes, for example, a semiconductor memory and/or a storage device. The semiconductor memory includes a memory card, a read only memory (ROM), a flash memory, a programmable logic circuit, or other semiconductor memories. The storage device includes a tape, a disk, a hard disk drive (HDD), a solid-state drive (SSD), or other storage devices. An electronic equipment (for example, a CPU, a controller, a microcontroller, or a microprocessor) may read and execute the programming codes from the non-transitory machine-readable storage medium, thereby implementing the relevant functions of the touch processing circuit 112 and (or) the host circuit 113. Alternatively, the programming codes may be provided to the electronic equipment via any transmission medium (for example, a communication network, a broadcast wave, etc.). The communication network is, for example, the Internet, a wired communication network, a wireless communication network, or other communication media.

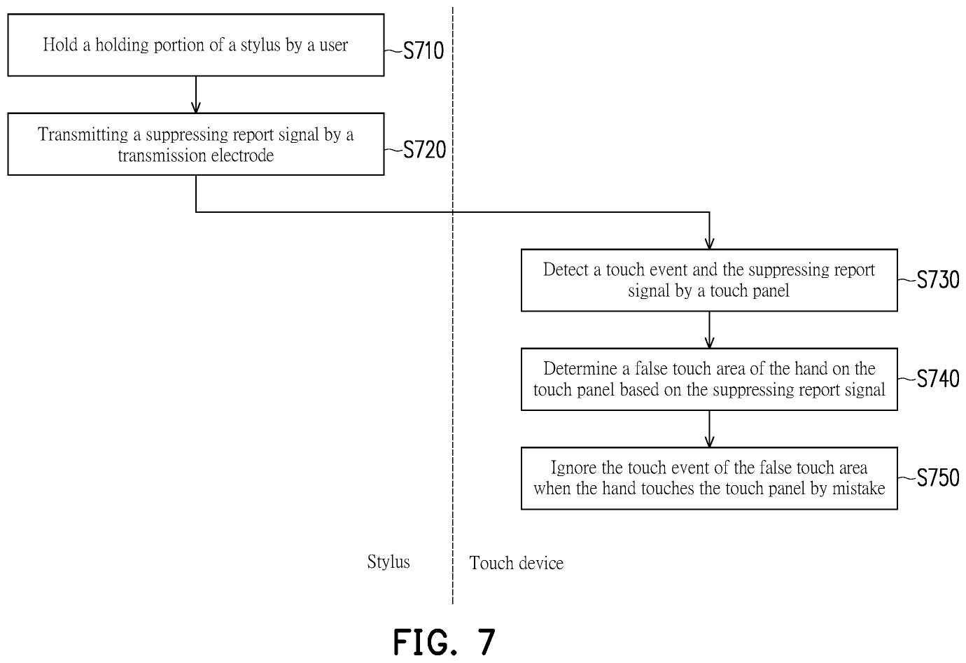

FIG. 7 is a schematic flowchart of an operation method according to an embodiment of the disclosure. Please refer to FIG. 1 and FIG. 7. In Step S710, the holding portion (for example, the body) of the stylus 120 may be held by the user to use the stylus 10. In the case where the hand 10 of the user holds the stylus 120, the transmission electrode TX1 disposed on the body (the holding portion) may transmit the suppressing report signal SRS to the touch panel 111 through the hand 10 (Step S720). The suppressing report signal SRS is used to make the touch device 110 to ignore the touch event of the hand 10 on the false touch area FTA of the touch panel 111. The touch processing circuit 112 is coupled to the touch panel 111 to detect the touch event and the suppressing report signal SRS (Step S730). In Step S740, the touch processing circuit 112 may determine the false touch area FTA of the hand 10 on the touch panel 111 based on the suppressing report signal SRS. When the hand 10 touches the false touch area FTA of the touch panel 111 by mistake, the touch processing circuit 112 may ignore the touch event of the false touch area FTA (Step S750).

In summary, the holding portion (for example, the body) of the stylus 120 described in the above embodiments is provided with the transmission electrode TX1. When the hand 10 holds the stylus 120 and approaches the touch panel 111, the suppressing report signal SRS of the transmission electrode TX1 may be transmitted to the touch panel 111 through the hand 10. The touch device 110 detects the suppressing report signal SRS of the hand 10 through the touch panel 111 to determine the false touch area FTA of the hand 10 on the touch panel 111. Therefore, in the case where the hand 10 holds the stylus 120, the touch device 110 may instantly and effectively identify the false touch area FTA of the hand 10. When the palm (or the wrist) touches the panel 111 by mistake, the touch device 110 may ignore the touch event of the false touch area FTA based on the suppressing report signal SRS.

The implementation manners of the touch processing circuit 112 may be determined according to the actual design. For example, the touch processing circuit 112 shown in FIG. 1 includes a driving circuit DRV1 and a microcontroller MCU1. The driving circuit DRV1 is used to be coupled to the touch panel 111. In the case where the hand 10 of the user holds the stylus 120, the stylus 120 may transmit the suppressing report signal SRS to the touch panel 111 through the hand 10. The driving circuit DRV1 may detect the suppressing report signal SRS of the transmission electrode TX1 of the stylus 120 through the touch panel 111. The microcontroller MCU1 is coupled to the driving circuit DRV1. The microcontroller MCU1 may determine the false touch area FTA of the hand 10 on the touch panel 111 based on the suppressing report signal SRS. When the hand 10 touches the false touch area FTA of the touch panel 111 by mistake, the microcontroller MCU1 may ignore the touch event of the false touch area FTA.

Although the disclosure has been disclosed in the embodiments, the embodiments are not intended to limit the disclosure. Persons skilled in the art may make some changes and modifications without departing from the spirit and scope of the disclosure. Therefore, the protection scope of the disclosure shall be defined by the appended claims.

1. A touch system, comprising:
a stylus, comprising a holding portion and a first transmission electrode, wherein the first transmission electrode is a wire or at least one conductor ring disposed on an outer surface of the holding portion, and the first transmission electrode disposed on the outer surface of the holding portion generates a suppressing report signal, and transmits the suppressing report signal in a case where a hand holds the holding portion of the stylus; and
a touch device, comprising a touch panel to detect a touch event, wherein the touch device detects the suppressing report signal of the first transmission electrode through the touch panel to determine a false touch area of the hand on the touch panel, and the touch device ignores the touch event of the false touch area when the hand touches the false touch area by mistake.

2. The touch system according to claim 1, wherein the first transmission electrode transmits a suppressing report signal through the hand of the user in a case where the hand holds the holding portion of the stylus.

3. The touch system according to claim 1, wherein the first transmission electrode electrically contacts the hand when the hand holds the holding portion.

4. The touch system according to claim 1, wherein the stylus further comprises an insulating layer disposed on the first transmission electrode, and the insulating layer prevents the first transmission electrode from electrically contacting the hand when the hand holds the holding portion.

5. The touch system according to claim 1, wherein the stylus further comprises:
a controller, coupled to the first transmission electrode, wherein the controller transmits the suppressing report signal through the first transmission electrode; and
a second transmission electrode, coupled to the controller, wherein the second transmission electrode is disposed at a tip portion of the stylus, the controller transmits a downlink signal to the touch panel through the second transmission electrode in a case where the tip portion is close to the touch panel, the downlink signal is different from the suppressing report signal, and the touch device judges a touch position of the tip portion on the touch panel based on the downlink signal of the second transmission electrode.

6. The touch system according to claim 1, wherein the touch device further comprises:
a touch processing circuit, coupled to the touch panel to detect the touch event, wherein the touch processing circuit detects the suppressing report signal of the first transmission electrode through the touch panel to determine the false touch area of the hand on the touch panel, and the touch processing circuit ignores the touch event of the false touch area when the hand touches the false touch area by mistake.

7. The touch system according to claim 6, wherein the touch processing circuit comprises:
a driving circuit, coupled to the touch panel, wherein the driving circuit detects the suppressing report signal of the first transmission electrode through the touch panel; and
a microcontroller, coupled to the driving circuit, wherein the microcontroller determines the false touch area of the hand on the touch panel, and the microcontroller ignores the touch event of the false touch area when the hand touches the false touch area by mistake.

8. An operation method of a touch system, comprising:
transmitting a suppressing report signal by a first transmission electrode of a stylus, wherein the first transmission electrode is a wire or at least one conductor ring disposed on an outer surface of a holding portion of the stylus, the first transmission electrode disposed on the outer surface of the holding portion generates the suppressing report signal, and transmits the suppressing report signal in a case where a hand holds the holding portion of the stylus;
detecting the suppressing report signal of the first transmission electrode by a touch panel of a touch device;
determining a false touch area of the hand on the touch panel based on the suppressing report signal; and
ignoring a touch event of the false touch area when the hand touches the false touch area by mistake.

9. The operation method according to claim 8, wherein the first transmission electrode transmits the suppressing report signal through the hand of the user in a case where the hand holds the holding portion of the stylus.

10. The operation method according to claim 8, wherein the first transmission electrode electrically contacts the hand when the hand holds the holding portion.

11. The operation method according to claim 8, wherein the stylus further comprises an insulating layer disposed on the first transmission electrode, and the insulating layer prevents the first transmission electrode from electrically contacting the hand when the hand holds the holding portion.

12. A stylus, comprising:
a holding portion; and
a first transmission electrode, wherein the first transmission electrode is a wire or at least one conductor ring disposed on an outer surface of the holding portion, wherein the first transmission electrode disposed on the outer surface of the holding portion generates a suppressing report signal, and transmits the suppressing report signal in a case where a hand holds the holding portion of the stylus, wherein the suppressing report signal is used to make a touch device to ignore a touch event of a false touch area of the hand on a touch panel.

13. The stylus according to claim 12, wherein the first transmission electrode transmits the suppressing report signal through the hand of the user in a case where the hand holds the holding portion of the stylus.

14. The stylus according to claim 12, wherein the first transmission electrode electrically contacts the hand when the hand holds the holding portion.

15. The stylus according to claim 12, further comprising
an insulating layer, disposed on the first transmission electrode, wherein the insulating layer prevents the first transmission electrode from electrically contacting the hand when the hand holds the holding portion.

16. The stylus according to claim 12, further comprising:
a controller, coupled to the first transmission electrode, wherein the controller transmits the suppressing report signal through the first transmission electrode; and
a second transmission electrode, coupled to the controller, wherein the second transmission electrode is disposed at a tip portion of the stylus,
wherein the controller transmits a downlink signal to the touch panel through the second transmission electrode in a case where the tip portion is close to the touch panel, the downlink signal is different from the suppressing report signal, and the touch device judges a touch position of the tip portion on the touch panel based on the downlink signal of the second transmission electrode.

17. An operation method of a stylus, comprising:
providing a holding portion of the stylus; and
transmitting a suppressing report signal by a first transmission electrode of the stylus, wherein the first transmission electrode is a wire or at least one conductor ring disposed on an outer surface of the holding portion, wherein the first transmission electrode disposed on the outer surface of the holding portion generates the suppressing report signal, and transmits the suppressing report signal in a case where a hand holds the holding portion of the stylus, wherein the suppressing report signal is used to make a touch device to ignore a touch event of a false touch area of the hand on a touch panel.

18. The operation method according to claim 17, wherein the first transmission electrode transmits the suppressing report signal through the hand of the user in a case where the hand holds the holding portion of the stylus.

19. The operation method according to claim 17, wherein the first transmission electrode electrically contacts the hand when the hand holds the holding portion.

20. The operation method according to claim 17, wherein the stylus further comprises an insulating layer disposed on the first transmission electrode, and the insulating layer prevents the first transmission electrode from electrically contacting the hand when the hand holds the holding portion.

21-26. (canceled)

27. A touch system, comprising:
a stylus, comprising a holding portion and a first transmission electrode, wherein the first transmission electrode is a wire or at least one conductor ring disposed on the holding portion, and the first transmission electrode transmits a suppressing report signal in a case where a hand holds the holding portion of the stylus, wherein the stylus further comprises an insulating layer, and the first transmission electrode is disposed between the insulating layer and the holding portion; and
a touch device, comprising a touch panel to detect a touch event, wherein the touch device detects the suppressing report signal of the first transmission electrode through the touch panel to determine a false touch area of the hand on the touch panel, and the touch device ignores the touch event of the false touch area when the hand touches the false touch area by mistake.

28. The touch system according to claim 27, wherein the first transmission electrode transmits a suppressing report signal through the hand of the user in a case where the hand holds the holding portion of the stylus.

29. The touch system according to claim 27, wherein the first transmission electrode electrically contacts the hand when the hand holds the holding portion.

30. The touch system according to claim 27, wherein the insulating layer is disposed on the first transmission electrode, and the insulating layer prevents the first transmission electrode from electrically contacting the hand when the hand holds the holding portion.

31. The touch system according to claim 27, wherein the stylus further comprises:
a controller, coupled to the first transmission electrode, wherein the controller transmits the suppressing report signal through the first transmission electrode; and
a second transmission electrode, coupled to the controller, wherein the second transmission electrode is disposed at a tip portion of the stylus, the controller transmits a downlink signal to the touch panel through the second transmission electrode in a case where the tip portion is close to the touch panel, the downlink signal is different from the suppressing report signal, and the touch device judges a touch position of the tip portion on the touch panel based on the downlink signal of the second transmission electrode.

32. The touch system according to claim 27, wherein the touch device further comprises:
a touch processing circuit, coupled to the touch panel to detect the touch event, wherein the touch processing circuit detects the suppressing report signal of the first transmission electrode through the touch panel to determine the false touch area of the hand on the touch panel, and the touch processing circuit ignores the touch event of the false touch area when the hand touches the false touch area by mistake.

33. The touch system according to claim 32, wherein the touch processing circuit comprises:
a driving circuit, coupled to the touch panel, wherein the driving circuit detects the suppressing report signal of the first transmission electrode through the touch panel; and
a microcontroller, coupled to the driving circuit, wherein the microcontroller determines the false touch area of the hand on the touch panel, and the microcontroller ignores the touch event of the false touch area when the hand touches the false touch area by mistake.

34. A stylus, comprising:
a holding portion; and
a first transmission electrode, be a wire or at least one conductor ring disposed on the holding portion, wherein the first transmission electrode transmits a suppressing report signal in a case where a hand holds the holding portion of the stylus, wherein the stylus further comprises an insulating layer, and the first transmission electrode is disposed between the insulating layer and the holding portion, wherein the suppressing report signal is used to make a touch device to ignore a touch event of a false touch area of the hand on a touch panel.

35. The stylus according to claim 34, wherein the first transmission electrode transmits the suppressing report signal through the hand of the user in a case where the hand holds the holding portion of the stylus.

36. The stylus according to claim 34, wherein the first transmission electrode electrically contacts the hand when the hand holds the holding portion.

37. The stylus according to claim 34, wherein the insulating layer prevents the first transmission electrode from electrically contacting the hand when the hand holds the holding portion.

38. The stylus according to claim 34, further comprising:
a controller, coupled to the first transmission electrode, wherein the controller transmits the suppressing report signal through the first transmission electrode; and
a second transmission electrode, coupled to the controller, wherein the second transmission electrode is disposed at a tip portion of the stylus,
wherein the controller transmits a downlink signal to the touch panel through the second transmission electrode in a case where the tip portion is close to the touch panel, the downlink signal is different from the suppressing report signal, and the touch device judges a touch position of the tip portion on the touch panel based on the downlink signal of the second transmission electrode.
